(19) United States
(12) Patent Application Publication
(10) Pub. No.: US 2015/0095001 A1
(43) Pub. Date: Apr. 2, 2015

(54) METHOD FOR DETERMINING MINERALOGICAL COMPOSITION

(71) Applicant: Gérard Massonnat, Pau (FR)

(72) Inventor: Gérard Massonnat, Pau (FR)

(73) Assignee: TOTAL SA, Courbevoie (FR)

(21) Appl. No.: 14/388,546

(22) PCT Filed: Mar. 27, 2012
(86) PCT No.: PCT/FR2012/050642

§ 371 Date: Sep. 26, 2014

(51) Int. Cl. G01V 99/00

(52) U.S. Cl. CPC G01V 99/005
USPC 703/6

(57) ABSTRACT

The present invention relates to simulating modifications to the mineralogical compositions of soil. This simulation includes: simulating a stochastic movement of a particle in a geological model and modifying the mineralogical composition attached to the model. This modification is based on at least the coordinates for the particle in the model, the aggressiveness of the particle, and the local mineralogical composition. As a result, the aggressiveness of the particle is also modified.

### RELATED APPLICATION

The present application is a National Phase entry of PCT Application No. PCT/FR2012/050642, filed Mar. 27, 2012, which application is incorporated herein in its/their entirety by reference.

### FIELD OF THE INVENTION

The present invention relates to the field of geological modeling. In particular, it is directed at modeling the evolution of the mineralogical composition and of the changes in the facies of geological soil.

### BACKGROUND OF THE INVENTION

The determination of a soil's sedimentary facies and mineralogical composition is often a necessary step in determining the ability of the soil to trap hydrocarbons.

A facies is used to describe a lithostratigraphic level, a rock, or a mineral. For example, one can speak of an isometric facies (minerals/rocks having dimensions that are substantially equal in the three spatial directions, such as galena or garnets), an elongated facies (minerals/rocks having crystals developed only in one direction), or a tabular facies (minerals/rocks having crystals developed in two spatial directions), etc.

In order to determine these facies, it may be useful to perform drilling at different points of interest. In this manner, it is possible to determine the different facies vertically from the drill cores, according to the depth.

Such methods are not without deficiencies.

The drilling sites may turn out to be expensive and they only allow obtaining information at a limited number of points, as the drilled holes may be spaced more than a hundred meters apart.

There is thus a need to improve the existing methods used in soil modeling in order to be able to assess with precision the petrophysical properties (porosity, permeability, etc.) of the soil in non-drilled areas.

The object of the present invention is therefore to improve this situation.

To this end, the present invention proposes modeling modifications to the mineralogical composition of soil.

### SUMMARY OF THE INVENTION

The present invention therefore provides a method, realized by computer, for simulating modifications to mineralogical compositions of soil. This method comprises:
/a/ receiving a geological model of said soil, wherein the model comprises at least one local mineralogical composition parameter based on local coordinates in this model;
/b/ simulating a stochastic movement of a particle in the geological model, said particle having coordinates in said model and having an “aggressiveness” parameter;
/c/ modifying the local mineralogical composition parameter while taking into account at least:
   the coordinates of the particle in said model,
   the aggressiveness of the particle, and
   the local mineralogical composition parameter;
/d/ modifying the aggressiveness of the particle while taking into account at least the modification of the local mineralogical composition of step /c/;
/e/ when an end condition is satisfied, supplying the local mineralogical composition parameter, otherwise repeating steps /b/, /c/, /d/ and /e/.

The term “mineralogical composition parameter” (or simply “mineralogical composition”) is understood to mean a parameter representing the ratios of minerals (such as sulfur, galena, cassiterite, fluoride, calcite, colemanite, chalcanthite, legrandite, etc.) within a portion of the soil, but also the ratios of other non-mineral chemical compounds such as molecules (for example CO₂, O₂, etc.) or ions (Ca²⁺, HCO₃⁻, etc.).

The term “aggressiveness parameter” (or simply “aggressiveness”) is understood to mean the capacity of a particle to modify a mineralogical composition parameter of the soil.

Advantageously, this method allows estimating the mineralogical composition of soil in order to estimate its petrophysical properties over time.

As an illustration, the supplied model may be constructed by geologists based on data from drilling site points. This model represents, for example, soil as it existed millennia ago during its formation, its compaction, etc.

In one particular embodiment, the local mineralogical composition parameter can comprise a plurality of components, where each component can be associated with a ratio for a type of mineral in a mineralogical composition.

The modification of the local mineralogical composition parameter may also include modifications to the components, where each component may be modified to a different extent.

As an illustration, the local mineralogical composition parameter may include three components. For a coordinate point of the data in the model, the local mineralogical composition parameter may also include:
a component whose value is 0.3 to indicate that calcite represents 30% of the composition of the soil.
a component whose value is 0.6 to indicate that dolomite represents 60% of the composition of the soil.
a component whose value is 0.1 to indicate that clay represents 10% of the composition of the soil

Advantageously, the components can be modified to a different extent during the simulation. The particles introduced in the model may not have the same capacity for dissolving or precipitating various minerals or reacting with various chemical compounds. For example, one particle can have a high capacity for dissolving calcite but no capacity for dissolving clay.

In addition, the modification of the mineralogical composition may be selected from among: dissolution, precipitation, or change of lithology with change of porosity.

The modification of the mineralogical composition may be configured by a parameter selected from among: one or more minerals as subjects of the modification, maximum/minimum porosity of the model, maximum/minimum conduit diameter, reactivity index for each mineral, facies transformation, modification inhibitor, modification kinetics, mineral to be transformed, mineral to be created, and minimum and maximum rates of change of a mineral.

In one embodiment of the invention, and for at least one component of the local mineralogical composition parameter, the modification of the component can include an increase in the ratio associated with said component.

In addition, and for at least one component of the local mineralogical composition parameter, the modification of the component can include a decrease in the ratio associated with said component.

Therefore, increasing the ratio associated with the component makes it possible to simulate the precipitation of a mineral or the creation of a chemical compound in the soil, while decreasing the ratio associated with the component makes it possible to simulate the dissolution of a mineral or the disappearance of a chemical compound in the soil.

Alternatively, steps /b/, /c/, /d/ and /e/ mentioned above can be applied to a plurality of particles.

In this manner, it is possible to simulate a large number of unit modifications to the model. This large number of modifications make it possible to obtain a more reliable representation of the mineralogical structure of a soil sample.

In one particular embodiment, the particle may include a mineralogical composition parameter. Then the aggressiveness of the particle can be based on:
the mineralogical composition parameter for the particle,
the local mineralogical composition parameter for the model, and
the coordinates of the particle in said model.

The term “mineralogical composition parameter for the particle” is understood to mean a parameter representing the ratios of the minerals present in the particle, either in suspended form or in dissolved form. It is also understood that this expression includes also other chemical compounds of the non-mineral type, such as molecules (for example CO₂, O₂, etc.) or ions (Ca²⁺, HCO₃⁻, etc.).

In addition, the aggressiveness parameter may include a plurality of components, where each aggressiveness component can be associated with the capacity of the particle to dissolve or to precipitate a certain type of mineral in the presence of a mineralogical composition.

Advantageously, this characteristic can be used to simulate different levels of aggressiveness of the particle depending on the chemical/mineralogical composition of the grid cell in which it is located. Therefore, if the aggressiveness has three components [0.2; −0.9; 0], the simulated particle may possess a low capacity for dissolving calcite (i.e. 0.2) and a very high capacity for precipitating dolomite (i.e. −0.9), while having no capacity for dissolving or precipitating clay (i.e. 0).

A device for simulating modifications to mineralogical compositions of soil can be advantageous in and of itself, if it makes it possible to provide a representation of the mineralogical composition of soil over time.

The present invention therefore also relates to a device for simulating modifications to the mineralogical compositions of soil, wherein said device is configured to implement the steps of the method described above.

A computer program implementing all or part of the method described above, installed on existing equipment, is advantageous in and of itself, if it allows such a simulation.

The present invention therefore also relates to a computer program including instructions for implementing the method described above when the program is executed by a processor.

### BRIEF DESCRIPTION OF THE DRAWINGS

Other characteristics and advantages of the invention will become apparent upon reading the following description. This description is purely illustrative and it should be read in conjunction with the attached Figures, which show the following:

FIG. 1 shows an example of a geological section in a karst region;

FIG. 2 is an example of a representation of a gridded geological model;

FIGS. 3a through 3c illustrate the phenomenon of changing the mineralogical composition of grid cells of a model in an embodiment according to the invention;

FIG. 4 shows an example of a device for changing the mineralogical composition of grid cells of a model in an embodiment according to the invention;

FIG. 5 is a functional diagram of one embodiment according to the invention.

### DETAILED DESCRIPTION OF THE DRAWINGS

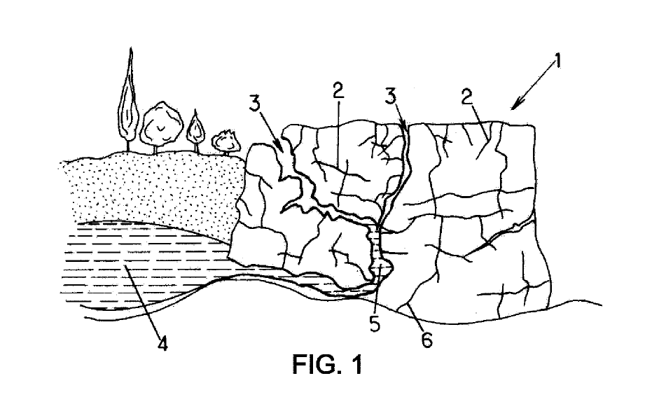

FIG. 1 shows an example of a geological section in a karst region 1. This region 1 includes fractures 2, 6, and cavities 3, 5 in a rock. As the region 1 is partially flooded, for example due to the proximity of a water table 4, the fractures 6 and cavities 5 may be filled with water.

The rock may, for example, include limestone, or more generally carbonate rocks.

Rain water, or water originating from the water table 4 or from hydrothermal upwellings, can infiltrate through gaps such as pores in the rock, fractures 2, 6, and/or cavities 3, 5. This infiltration increases the size of these gaps due to the dissolution of carbonates within the rock into the infiltrated water, which can lead to the formation of cavities.

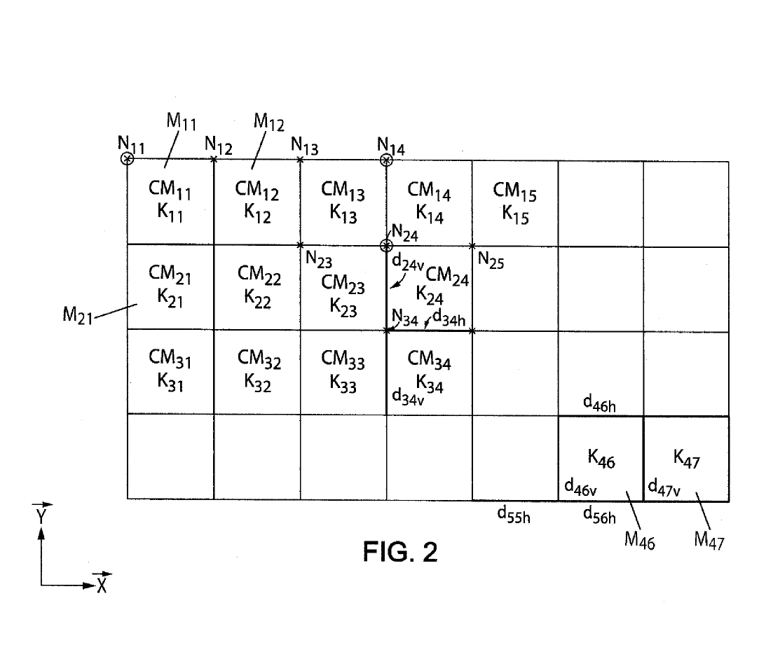

FIG. 2 schematically illustrates an example of a gridded geological model according to an embodiment of the invention. This model can be used to simulate changes in the petrophysical characteristics of soil (in particular through the mineralogical composition of the soil), the soil possibly being heterogeneous sedimentary soil.

Indeed, the phenomena of dissolution, precipitation and change of lithology may occur naturally in a geological environment and such a model makes it possible to simulate them.

Modeling the karst region with a geological model, for example a gridded model, can be advantageous in the context of the simulation according to the embodiments of the invention. In fact, the gridded structure of a geological model simplifies simulation using computers and software which natively handle these grid structures.

In this model, the movement of particles is simulated in a network (or geological model). The particles represent water that has infiltrated the rock. Each particle can, for example, correspond to a drop of water or to a water molecule.

The gridded geological model can be two-dimensional, for example as illustrated in FIG. 2 for clarity's sake, or, preferably, three-dimensional.

The model of FIG. 2 comprises grid cells M₁₁, M₁₂, M₂₁, . . . , M₄₆, M₄₇, etc.

In this embodiment, it is expected that each cell Mᵢⱼ will by default be assigned a geological parameter value for the cell (for example a permeability value Kᵢⱼ), but also a mineralogical composition value (designated as CMᵢⱼ). The variables i and j indicate the spatial positions of the cells. Therefore, for each cell M₁₁, M₁₂ . . . there is a corresponding permeability value K₁₁, K₁₂, etc., and a corresponding mineralogical composition CM₁₁, CM₁₂, etc. These values are used to describe a first environment. The probability of the stochastic movement of a particle in the first environment is calculated while taking into account the permeability values Kᵢⱼ so as to simulate flow in porous rock, which is also called a matrix.

A second environment is described by edge parameter values, for example the diameter of conduits d₂₄ᵥ (vertical edge between two nodes N₂₄ and N₃₄), d₃₄ₕ (horizontal edge between two nodes N₃₄ and N₃₅), etc. The probability of stochastic movement of a particle in the second environment is calculated while taking into account these conduit diameter values d₂₄ᵥ, etc., so as to simulate flow through the fractures.

The particles may be introduced at a given node, for example N₁₁, or at several nodes. The introduction of particles can be performed at predetermined periodic intervals.

In this embodiment, it is assumed that the particles are subjected to two types of movement: “advective movement” and “dispersive movement”. “Advective movement” (or, for the latter, “advective direction”) is the most likely movement of the particle (or, for the latter, the most likely direction of movement of the particle). For a given cell, the advective movement is likely to take place in one direction and orientation, determined by the hydraulic gradient corresponding to the modeled region based on whether this region is or is not saturated.

In addition, limestone lithologies can be characterized by a reaction index IRᵢⱼ (or dolomitization index IDᵢⱼ in the case of limestone) describing the capacity of their mineralogical compositions to be modified (or respectively the capacity of the limestone to be transformed into dolomite).

One can thus predict that the particles introduced into the model may cause the mineralogical composition parameters of the first model (matrix) to evolve during the course of the simulation. Precipitating elements in significant proportions may cause a change of lithology and thus of the facies of the rock (for example a dolomitization phenomenon), in particular based on the aggressiveness of the particles, the current (or initial) mineralogical composition CMᵢⱼ of the matrix, the current reaction index IRᵢⱼ, the chemical content of the particle, etc.

The diagenesis of the rock can be also taken into account, namely the type of action of the particles on the rock during their movement. For example, the type of action of the particles on the rock is selected from among the following:
dissolution, whereby the water dissolves the rock,
precipitation, whereby the ions dissolved in the water are deposited on the rock,
change in lithology related to a change (increase or decrease) in the porosity.

Using dissolution as an example, the parameters taken into account can be the following:
the minerals to be dissolved (chosen for example from a list including limestone, dolomite, limestone dolomite, dolomitic limestone, argillaceous sandstone, and argillaceous limestone, in predefined ratios),
a maximum porosity value for the matrix and/or a maximum conduit diameter value which can be obtained with dissolution,
a reactivity index (between 0 and 1), which can be defined for each of the minerals,
a transformation of the facies, defining the values both before and after dissolution,
an inhibitor of the dissolution reaction,
the kinetics of the dissolution reaction (taking into account, for example, factors such as the temperature, activation energy, etc.).

In the case of precipitation, similar parameters can be defined to take into account the particular characteristics of precipitation in the rock in question. For example, the minimum porosity and diameter values can be defined instead of the maximum values defined for dissolution.

In the case of a change in lithology, it is possible to determine for example:
the mineral to be transformed,
the mineral created,
the transformation of the facies, defining the values both before and after the changes in lithology,
the minimum and maximum rates of change of the mineral,
inhibitors or kinetics as mentioned above.
These parameters can be defined, where applicable, for either one or for both environments.

In this case, the particle aggressiveness describes the capacity of the particle for transforming the lithology or the chemical composition of the affected rock.

The particles can have variable characteristics, for example depending on their coordinates in the model, the simulation time, the distance traveled by a particle, the type of fluid, etc. In particular, the particle may lose aggressiveness in the case of dissolution, while its aggressiveness may be increased in the case of precipitation.

An example of the stochastic movement simulation model for particles is described in patent application PCT/FR2011/052099.

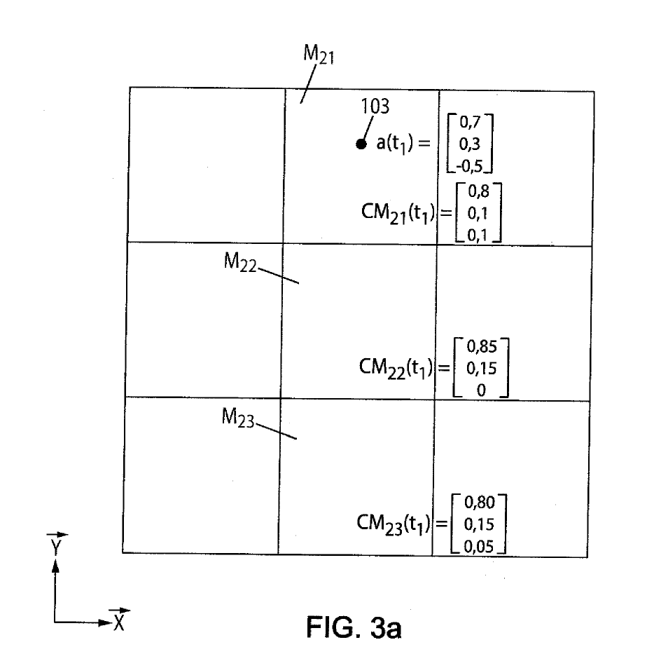

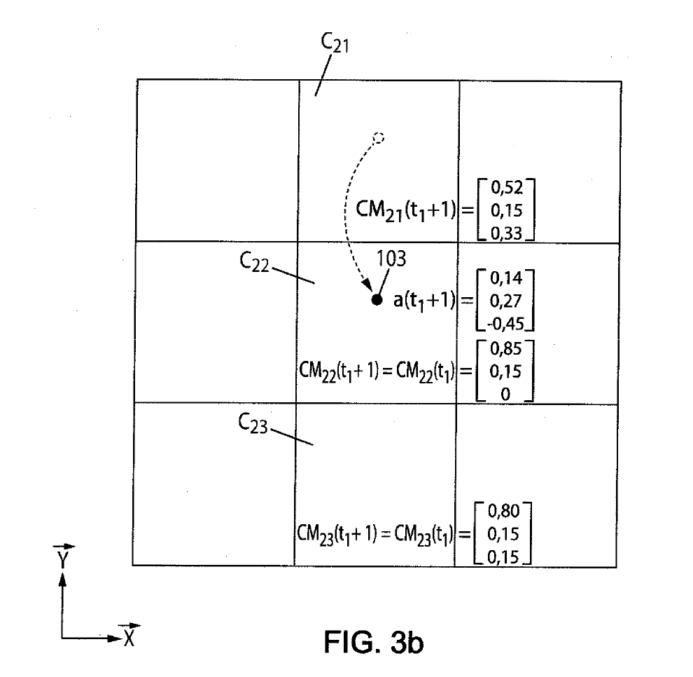

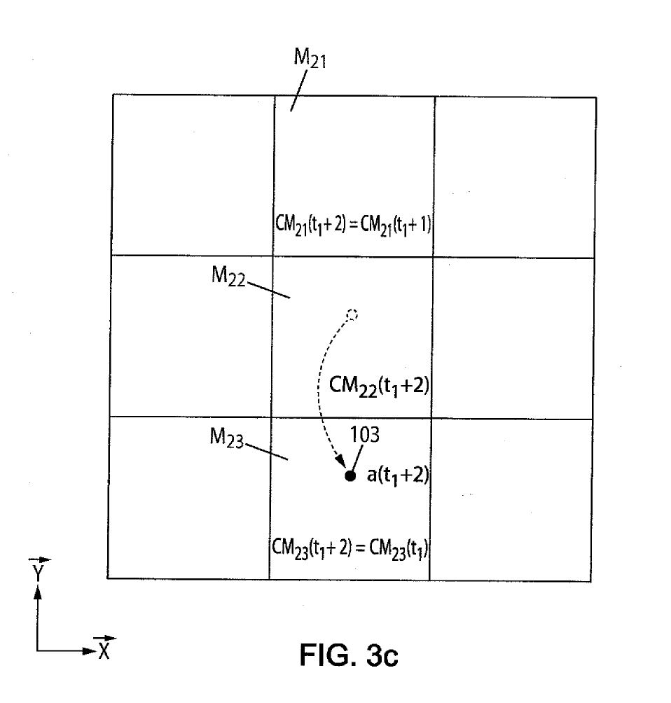

FIGS. 3a and 3c illustrate the phenomenon of modifying the mineralogical composition of cells of a model in an embodiment according to this invention.

In these Figures, in order to simplify the description, it is assumed that the rocks represented in the model are limestone rocks, but other compositions such as shale and sandstone are also possible.

Limestone rocks are readily soluble in water and consist mostly of calcium carbonate (CaCO₃). By way of an example, several minerals/rocks which may be included in the composition of a rock are listed below:
Calcite: a mineral consisting of calcium carbonate (CaCO₃), with traces of Mn, Fe, Zn, Co, Ba, Sr, Pb, Mg, Cu, Al, Ni, V, Cr, Mo;
Dolomite: a mineral consisting of calcium carbonate and magnesium having the chemical formula CaMg(CO₃)₂ and with traces of Fe, Mn, Co, Pb, Zn;
Clay: a sedimentary rock containing at least 50% alumina silicate, to which are added other minerals (quartz, feldspar, calcite, iron oxides).

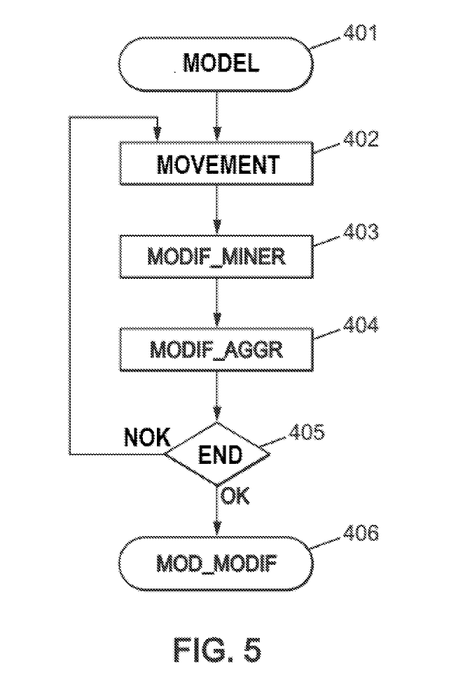

FIG. 3a shows a two-dimensional gridded geological model at simulation time t. By way of simplification, this model includes 9 cells. This model may for example have been obtained (step 401 in FIG. 5) from simulation software by electronic means, via a connection interface (for example a USB interface, an Ethernet interface, or a bus connection to a hard drive).

Each of the cells in this model has a mineralogical composition that is provided and fixed prior to the simulation. The mineralogical composition of cell M₂₁ is indicated as CM₂₁(t), the mineralogical composition of cell M₂₂ is indicated as CM₂₂(t), and the mineralogical composition of cell M₂₃ is indicated as CM₂₃(t). The model is therefore described as having a local mineralogical composition parameter which can depend on the cell in question (i.e. the coordinates of the cell concerned in the model).

At time t₁, a particle 103 is present in cell M₂₁ and has an aggressiveness a(t₁) (or aggressiveness parameter). The aggressiveness of the particle can be represented by a vector of numeric values, where each numeric value of this vector represents a capacity of the particle for modifying a given mineral. By way of an example, it is assumed that this particle 103 has an aggressiveness vector which is equal to [calcite=0.7; dolomite=0.3; clay=−0.5](or simply [0.7; 0.3; −0.5]). In the present case, this vector indicates that the particle 103 has a high capacity for dissolving calcite (i.e. 0.7), a low capacity for dissolving dolomite (i.e. 0.3), and an average capacity for precipitating clay (i.e. −0.5).

In addition, the mineralogical composition of the cell M₂₁ includes, for example, a large amount of dolomite and a small amount of calcite and clay: it is thus said that the proportions of dolomite, calcite and clay are the components of the mineralogical composition of cell M₂₁. These components can be written down in vector form as [0.8; 0.1; 0.1]=CM₂₁(t). By extension of this concept, the mineralogical composition of the cell can also include chemical compounds which are not explicitly considered to be minerals; for example, the mineralogical composition of a cell may also include molecules (such as CO₂, O₂, etc.), or ions (Ca²⁺, HCO₃⁻, etc.).

It is possible to simulate the stochastic movement of the particle between times t₁ and t₁+1 (step 402 in FIG. 5), particularly in relation with the methods presented in patent application PCT/FR2011/052099. For simplicity in the examples in FIGS. 3a to 3c, the simulated movement of the particle is considered to be vertical, in direction −\vec{y}.

Between times t₁ and t₁+1, it is also possible to simulate the fact that the presence of the particle in the matrix of cell M₂₁ induces a modification (step 403 of FIG. 5) to the mineralogical composition of the cell (or local mineralogical composition parameter). In fact, if the mineralogical composition of the cell includes dolomite and the particle also has the capacity to dissolve dolomite, the ratio of dolomite in the cell will consequently be decreased while the ratio of other minerals will be increased. The same will be true for the precipitation capacity of a given mineral, for which the ratio of the given mineral will be increased.

In the example in FIGS. 3a to 3c, we have a(t₁)=[0.7; 3; −0.5] and CM₂₁(t₁)=[0.8; 1; 0.1]. In one embodiment of the simulation, the new ratios for the mineralogical composition (after modification) of the cell can be determined as follows:
Step 1: intermediate mineralogical composition values are determined by multiplying the old ratio by the corresponding aggressiveness component and by subtracting the result of the old ratio calculation;
Step 2: once these intermediate values have been determined for each component, each of these intermediate values is divided by the sum of the determined intermediate values.

In the present case, the following result will be obtained in step 1: [0.8*(1−0.7); 0.1*(1−0.3); 0.1*(1+0.5)] which is [0.24; 0.07; 0.15]. In addition, the result in step 2 will

$$[ \frac{0.24}{0.46} ; \frac{0.07}{0.46} ; \frac{0.15}{0.46} ]$$

(because 0.24+0.07+0.15=0.46) or about [0.52; 0.15, 0.33). Other calculation methods are of course possible. In particular, each of the new components of the mineralogical composition may be a function of a plurality of old mineralogical composition components or of aggressiveness components so as to represent the underlying chemical reactions in more detail.

The aggressiveness of the particle may evolve (step 404 of FIG. 5) in response to this change in the mineralogical composition. Indeed, if the particle induces strong calcite dissolution, it is likely that its capacity to dissolve such a mineral will actually be reduced. In an embodiment of the simulation, the new aggressiveness components of the particle (after modification) can be determined by multiplying the old aggressiveness component by the associated ones' complement of the old mineralogical component (i.e. corresponding to the same mineral).

In this case, the following result would be obtained: [0.7*(1−0.8); 0.3*(1−0.1); −0.5*(1−0.1)] which is [0.14; 0.27; −0.45]. Other calculation methods are of course possible. In particular, a new aggressiveness component can be a function of a plurality of old aggressiveness components or local mineralogical composition components so as to represent the underlying chemical reactions in more detail.

Indeed, if the aggressiveness of the particle depends on its “ionic” composition (or, in inaccurate terms, its mineralogical composition), for example the concentration of acids or of Ca²⁺ or even of HCO₃⁻), the chemical mechanisms of precipitation or dissolution can cause the mineralogical composition of the particle to evolve and thus change its aggressiveness.

For example, based on the premise that the mineralogical composition of the particle 103 includes a high concentration of Ca²⁺ ions and that the mineralogical composition of cell M₂₁ includes HCO₃⁻ ions in suspension, precipitation of calcium carbonate may occur (which is a frequent situation in aquatic environments, in particular in marine environments). Once the ions have been precipitated, the concentration of Ca²⁺ ions in the particle is decreased and the particle thus loses its “aggressiveness”. It should be noted that in the latter case, the aggressiveness of the particle does not depend solely on the particle but also on the environment in which the particle is found: namely cell M₂₁.

Therefore, in FIG. 3b and at time t₁+1, the particle 103 is located in cell M₂₂. The aggressiveness of the particle a(t₁+1) at this moment has been modified between times t₁ and t₁+1 as a function of the modifications introduced into the mineralogical composition of cell M₂₁. The mineralogical composition of other cells (i.e. M₂₂ and M₂₃) was not modified, as no particles were located inside these cells between simulation times t₁ and t₁+1.

Also, at time t₁+2 in FIG. 3c, a repetition of the steps presented above can be carried out. In this manner, between times t+1 and t+2, the particle 103 moves from cell M₂₂ to cell M₂₃. The aggressiveness a(t₁+2) has been modified between time t₁+1 and time t₁+2 as a function of the modifications made to the mineralogical composition CM₂₂ of cell M₂₂. The mineralogical composition of other cells (i.e. M₂₁ and M₂₃) is unchanged, as no particles were located inside these cells between simulation times t₁+1 and t₁+2.

Finally, it is possible that the user has configured an end condition prior to the simulation, making it possible to terminate the simulation and thus avoid infinitely repeating the steps described above. This end condition may also be implicit. By way of an example, this end condition can be a maximum simulation time period beyond which the simulation should be stopped. This condition may also be the particle moving beyond the limits of the model, where it then no longer belongs to any cell, so that modifying the mineralogical composition is no longer possible. If the end condition is not satisfied (the NOK arrow in test 405), the process is repeated. If the end condition is satisfied (the OK arrow in test 405), the mineralogical composition parameter of the model is returned (message 406), for example for storage on the hard drive via a bus interface, or for graphical presentation to the user on a screen or console.

Obviously, although FIGS. 3a through 3c describe the movement of one particle, similar processing can be performed for a plurality of particles, for example 100,000 particles.

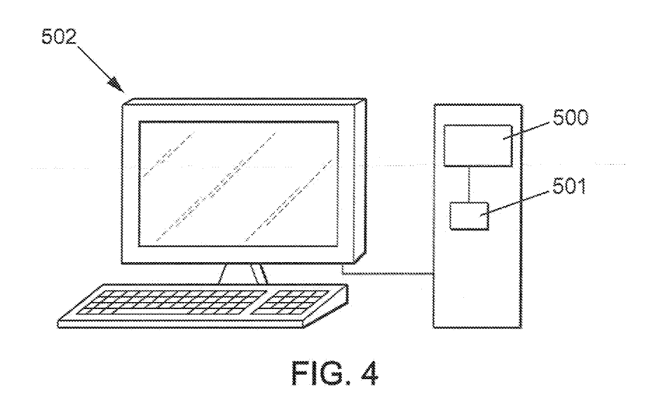

FIG. 4 shows an example of the simulation device 502. In this embodiment, the device 502 includes a computer, comprising a memory 500 for storing the gridded geological model, and a processing means, for example a processor 501 for carrying out simulations and determining the changes in the mineralogical composition of said model.

In addition, the functional diagram shown in FIG. 5 is a typical example of a program which has certain instructions that can be carried out with the simulation equipment. In this respect, FIG. 5 can correspond to the flowchart of a general algorithm of a computer program within the meaning of this invention.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1-12. (canceled)

13. A method, realized by computer, for simulating modifications to mineralogical compositions of soil, comprising:
/a/ receiving a geological model for said soil, wherein the model comprises at least one local mineralogical composition parameter based on local coordinates in this model;
/b/ simulating a stochastic movement of a particle in the geological model, said particle having coordinates in said model and having an aggressiveness parameter;
/c/ modifying the local mineralogical composition parameter while taking into account at least:
the coordinates of the particle in said model,
the aggressiveness of the particle, and
the local mineralogical composition parameter;
/d/ modifying the aggressiveness of the particle while taking into account at least the modification of the local mineralogical composition of step /c/; and
/e/ when an end condition is satisfied, supplying the local mineralogical composition parameter, otherwise repeating steps /b/, /c, /d/ and /e/.

14. The method according to claim 13, wherein the local mineralogical composition parameter comprises a plurality of components, each component being associated with a ratio for a type of mineral in a mineralogical composition,
and wherein the modification of the local mineralogical composition parameter comprises modifications to said components, each component being modified to a different extent.

15. The simulation method according to claim 14, wherein the modification of the mineralogical composition is selected from among: dissolution, precipitation, or change of lithology with change of porosity.

16. The simulation method according to claim 14, wherein the modification of the mineralogical composition is configured by a parameter selected from among: one or more minerals as subjects of the modification, a maximum/minimum porosity value of the model, a maximum/minimum conduit diameter value, a reactivity index for each mineral, a facies transformation, a modification inhibitor, the kinetics of the modification, a mineral to be transformed, a mineral to be created, and the minimum and maximum rates of change of a mineral.

17. The method according to claim 13, wherein for at least one component of the local mineralogical composition parameter, the modification of the component comprises increasing the ratio associated with said component.

18. The method according to claim 13, wherein for at least one component of the local mineralogical composition parameter, the modification of the component comprises decreasing the ratio associated with said component.

19. The method according to claim 13, wherein steps /b/, /c/, /d/ and /e/ are carried out for a plurality of particles.

20. The method according to claim 13, wherein the particle comprises a mineralogical composition parameter, and the aggressiveness of the particle is a function of:
the mineralogical composition parameter for the particle,
the local mineralogical composition parameter for the model, and
the coordinates of the particle in said model.

21. The method according to claim 13, wherein the aggressiveness parameter comprises a plurality of components, each aggressiveness component being associated with a capacity of the particle to dissolve or precipitate a certain type of mineral in the presence of a mineralogical composition.

22. A non-transitory computer readable storage medium, having stored thereon a computer program comprising program instructions, the computer program being loadable into a data-processing unit and adapted to cause the data-processing unit to carry out, when the computer program is run by the data-processing device:
/a/ receiving a geological model for said soil, wherein the model comprises at least one local mineralogical composition parameter based on local coordinates in this model;
/b/ simulating a stochastic movement of a particle in the geological model, said particle having coordinates in said model and having an aggressiveness parameter;
/c/ modifying the local mineralogical composition parameter while taking into account at least:
the coordinates of the particle in said model,
the aggressiveness of the particle, and
the local mineralogical composition parameter;
/d/ modifying the aggressiveness of the particle while taking into account at least the modification of the local mineralogical composition of step /c/;
/e/ when an end condition is satisfied, supplying the local mineralogical composition parameter, otherwise repeating steps /b/, /c/, /d/ and /e/.

23. A device for simulating modifications to the mineralogical compositions of soil, wherein said device comprises a processor for:
/a/ receiving a geological model for said soil, wherein the model comprises at least one local mineralogical composition parameter based on local coordinates in this model;
/b/ simulating a stochastic movement of a particle in the geological model, said particle having coordinates in said model and having an aggressiveness parameter;
/c/ modifying the local mineralogical composition parameter while taking into account at least:
the coordinates of the particle in said model,
the aggressiveness of the particle, and
the local mineralogical composition parameter;
/d/ modifying the aggressiveness of the particle while taking into account at least the modification of the local mineralogical composition of step /c/;
/e/ when an end condition is satisfied, supplying the local mineralogical composition parameter, otherwise repeating steps /b/, /c/, /d/ and /e/.

24. A production method for a hydrocarbon extraction facility, comprising the implementation of:
/a/ receiving a geological model for said soil, wherein the model comprises at least one local mineralogical composition parameter based on local coordinates in this model;
/b/ simulating a stochastic movement of a particle in the geological model, said particle having coordinates in said model and having an aggressiveness parameter;
/c/ modifying the local mineralogical composition parameter while taking into account at least:
the coordinates of the particle in said model,
the aggressiveness of the particle, and
the local mineralogical composition parameter:
/d/ modifying the aggressiveness of the particle while taking into account at least the modification of the local mineralogical composition of step /c/;
/e/ when an end condition is satisfied, supplying the local mineralogical composition parameter, otherwise repeating steps /b/, /c/, /d/ and /e/.
